(19) United States
(12) Patent Application Publication
(10) Pub. No.: US 2005/0149569 A1
(43) Pub. Date: Jul. 7, 2005

(54) Electronic lab notebook

(75) Inventors: Shankar Hariharan, Smithtown, NY (US); Ted Zurek, Woodbury, NY (US); Neeta LaGuerra, Garden City Park, NY (US); Michael Ripa, Coram, NY (US); Bhavna Aggarwal, Hicksville, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: Forest Laboratories, Inc., New York, NY (US)

(21) Appl. No.: 11/003,567

(22) Filed: Dec. 3, 2004

Related U.S. Application Data
(60) Provisional application No. 60/526,836, filed on Dec. 3, 2003.

(51) Int. Cl. G06F 7/00

(52) U.S. Cl. 707/104.1

(57) ABSTRACT

A laboratory activity electronic documentation and management system is provided. The system includes a first processor executing a set of instructions and a second processor connected to the first processor. The second processor is enabled by the set of instructions executed by the first processor to generate an electronic data record sheet for a study for a product family, the study comprising at least one test, the test comprising at least one template, the template comprising at least one task to be executed in a laboratory and status information for the task, such that the content and order of the study, the test, the template and the task can be defined by a user who operates the second processor. An inventory identification, such as a batch or lot number or an identification of an instrument part used to generated the laboratory data may also be stored.

### RELATED APPLICATION

The present application claims priority from U.S. Provisional Application 60/526,836 filed on Dec. 3, 2003, which provisional application is incorporated herein in full by reference.

### FIELD OF THE INVENTION

This invention relates generally to laboratory information management systems (LIMS). More specifically, the present invention relates to systems and methods for the design, organization and editing of studies and tests for pharmaceutical product analysis and experimentation, and to systems and methods for organizing, inputting, tracking, recording and reporting laboratory data gathered as results for the studies and tests.

### BACKGROUND OF THE INVENTION

The research and development of many pharmaceutical products require the generation of data based on various tests and procedures performed in laboratories. Laboratories require teams of researchers and lab technicians to generate data that must be maintained and organized. To coordinate tasks to be performed by laboratory personnel and to document laboratory results, laboratory information management systems (LIMS) are in use. Such systems facilitate the organization and processing of data generated by laboratories. Typically, such systems are in use in analytical laboratories, where tasks to be performed by laboratory personnel and functions to be carried out by instruments can be specified in detail in advance. For example, manufacturers of pharmaceuticals or chemicals that follow standard operating procedures, usually prepared by quality assurance personnel, require analytical laboratories. Similarly, testing required by government regulatory bodies, such as the FDA, or FDA approval mechanisms, require highly structured sets of tests and procedures in an analytical laboratory type setting.

Experimental laboratory activities, on the other hand, tend to be less regimented, and thus less amenable to pre-specified sets of procedures, since the final goal or product may not be known with specificity in advance. Thus, in a research laboratory, the procedures to be carried out in the lab may be developed in stages and are subject to revision.

While handwritten notebooks can be maintained by individual researchers, a computerized system to manage laboratory information is helpful to coordinate tasks to be performed and to organize the data generated, particularly when many laboratory personnel collaborate on a larger project. Also, security considerations require that the identity of personnel who change the protocol to be followed or who enter information into the system be verified and kept track of. Electronic laboratory information management systems facilitate the implementation of the security function. Also, the risk of transcription error increases if the data is transferred to paper before being manually transcribed into the system.

Prior art systems provide various types of laboratory information management systems. U.S. Pat. No. 6,581,020 to Buote et al. describes a system for managing and reporting laboratory data, wherein the procedures of the analytical method are used to manage the performance of tests, to receive and to record the resulting data, and to generate the required reports. To unify the laboratory environment, a unified data acquisition system is provided.

Boute's system, like other LIMSs, does not address the needs of a research and development setting, where experimentation does not allow for a well-defined set of procedures and tests.

Moreover, the prior art, including Boute's system, requires the installation of specialized software at multiple client workstations as well as at a centralized server. In addition to the initial installation of software, this also presents a substantial maintenance effort when software updates are required or when study design changes are implemented as required by the research.

More generally, a flexible and adaptable system would allow a user who is not an expert in software development to design his or her own studies as needed in a laboratory environment. In such a user-defined study, the content and order of tests and the content and order of the tasks that comprise the tests, could be designed, developed and modified by a user, such as a CMC or other laboratory personnel.

It would also be desirable for such a system to be implemented with conventional workstations with little or no specialized software required at each of the multiple workstations.

Further such a system in the prior art does not disclose a drill-down feature, which allows tracking of inventory identification, such as batch/lot numbers and instrument parts identifications used in the execution of the task, nor a job concept as disclosed herein.

### SUMMARY OF THE INVENTION

A laboratory activity electronic management system, method and medium is disclosed. A first processor can execute a set of instructions; and a second processor logically connected to said first processor may be enabled by the set of instructions executed by said first processor to enable a generation of an electronic data record sheet for a study for a product family, the study comprising at least one test, the test comprising at least one template that includes at least one task to be executed in a laboratory and status information for the task, an order of the study, the test, the template and the task being defined by a user operating said second processor. The second processor may enable a second user to enter generated laboratory information into the electronic data record sheet, the laboratory information generated in accordance with the execution of the task, such that the first processor is configured to store the electronic data record sheet with the entered laboratory information from said second processor, such that the template of the stored electronic data record sheet includes an inventory identification number, such as a batch number of a substance used to generate the laboratory information and an identification of an instrument part exposed to the substance used in an instrument for the execution of the task.

The test may also comprise a solution preparation template, at least one standard preparation template, at least one instrument preparation template, or at least one sample analysis template.

Also, the generation of a job is provided for, the job being a workflow entity comprising a single specified test to be performed in the laboratory for each sample of a specified group of samples, the samples being different from each other and belonging to the same product family.

The second user may record in the generated electronic data record sheet a quantity or a measurement different from the quantity and the measurement suggested by the task.

The inventory identification saved into the electronic data record sheet may be different from the batch number and the identification of the instrument part specified in the generated template.

The user may record into the generated electronic data record sheet results of a task performed in the order of the sequence defined by the generated electronic data record sheet.

### BRIEF DESCRIPTION OF THE DRAWINGS

FIG. 1 is a schematic block diagram depicting an exemplary embodiment of a system in accordance with the present invention.

FIG. 2 is a reproduction of the basic user interface screen of the preferred embodiment.

FIG. 3 shows creation of data comprising a “job” according to an embodiment of the invention.

FIGS. 4(a)-6(b) show examples of screens of an electronic notebook according to an embodiment of the present invention.

### DETAILED DESCRIPTION OF THE INVENTION

The following discussion and the foregoing figures describe embodiments of Applicant's invention as best understood presently by the inventors however, it will be appreciated that numerous modifications of the invention are possible and that the invention may be embodied in other forms and practiced in other ways without departing from the spirit of the invention. Further, features of embodiments described may be omitted, combined selectively or as a whole with other embodiments, or used to replace features of other embodiments, or parts thereof, without departing from the spirit of the invention. The figures and the detailed description are therefore to be considered as an illustrative explanation of aspects of the invention, but should not be construed to limit the scope of the invention.

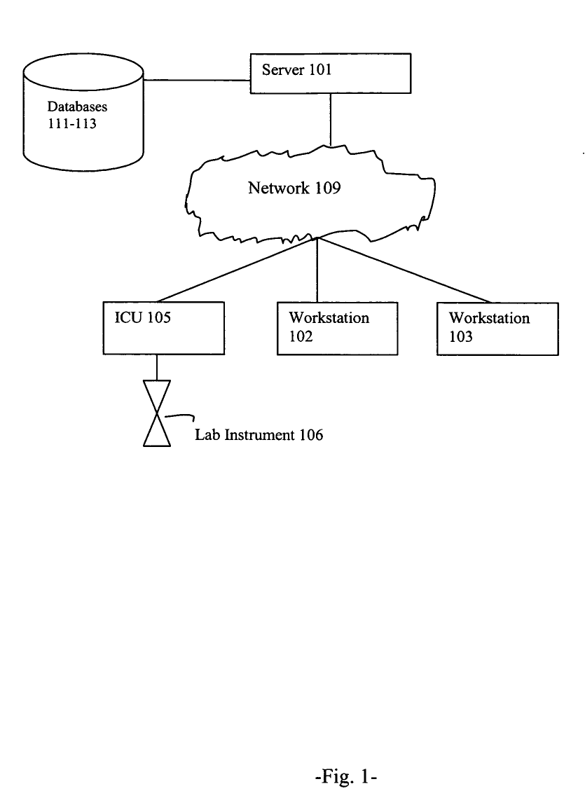

An embodiment of the present invention is shown in FIG. 1. A server 101 is logically connected to multiple workstations 102, 103. This connection may be via a data communication network 103, implemented as an Ethernet, LAN, WAN, Internet, extranet or the like. In accordance with the present invention, the server can be of known devices such as a database server, network file server, or a web application server that serves content to a Web browser by loading a file and serving it across the network to a user's Web browser using HTTP. A proxy server can be used between the client and the external server to filter requests, improve performance, and share connections. While two workstations 102 and 103 are shown, it will be understood that the number of workstations to be connected is limited only by the needs of the laboratory, and that only one workstation may also be connected.

A database may be logically connected to the server 101. The database, or a set of databases, may include an analytical methods store 110, a data repository 111, an employee database 112, and an instrument database 113. The analytical method store 110 contains various procedures to be executed by a system according to the present invention. The data repository 111 stores the data generated by the laboratory procedures. The employee database 112 includes employee information, including information about laboratory personnel necessary for identifying and authorizing personnel access data to enter data into the system. The instrument database 113 contains information relating to the various instruments with which the system interacts, including information for calibrating, servicing, maintaining and operating laboratory instruments, testing equipment and the like. Also, while the databases 110-113 are shown as a separate unit, the databases, or a portion of them, may be arranged physically integrated with the server 101.

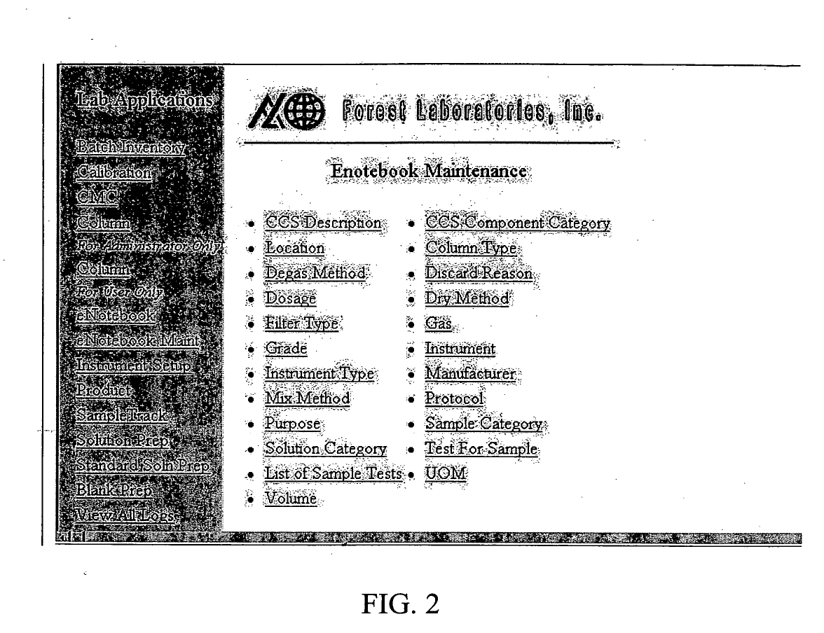

Also logically connected to the server via the network 109 or directly may be one or more instrument connection units (ICUs) 105, each of which is logically connected to one or more laboratory instruments 106. Each of the workstations 102, 103 is provided with a browser, as appropriate, such as a Web browser to interact with the server 101. JAVA server pages, Applets or servlets may be provided by the server 101 to communicate with the browser. While depicted in FIG. 1 as being directly connected to a network 109, workstations 102 and 103 and ICU 105 may be connected networked together on a separate network, such as a LAN (not shown), which second network is in turn connected via a gateway, network interface, or router to the network 109 shown in FIG. 2. Alternatively, the system may be used without network 109 with the workstations connected directly to the processor that executes the software instructions that provide the system. It will be understood that while the system is described with reference to software instruction, hardware, firmware, or a combination of the foregoing may be used to provide the necessary logic and instructions of the present invention.

It will be appreciated therefore, that according to an aspect of the invention specialized software embodying instructions for performing aspects of the system according to the present invention may be executed on the server 101, thus allowing for workstations 102, 103 to operate without software specially designed for the present invention.

Aspects of an operation of a system according to an embodiment of the present invention will now be described with reference to FIGS. 2-6. FIG. 2 shows an exemplary menu page according to an illustrative of embodiment of the present invention. The user, such as a CMC, can access various sections of the system.

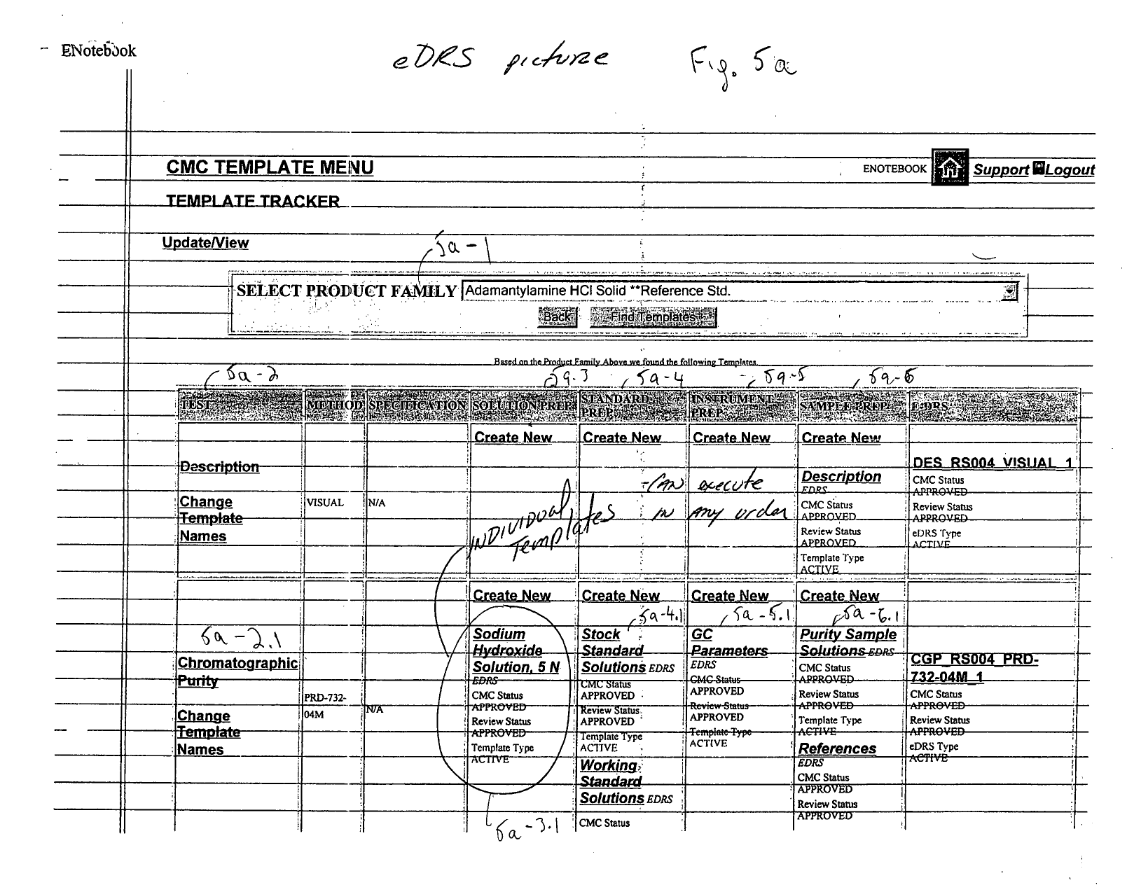

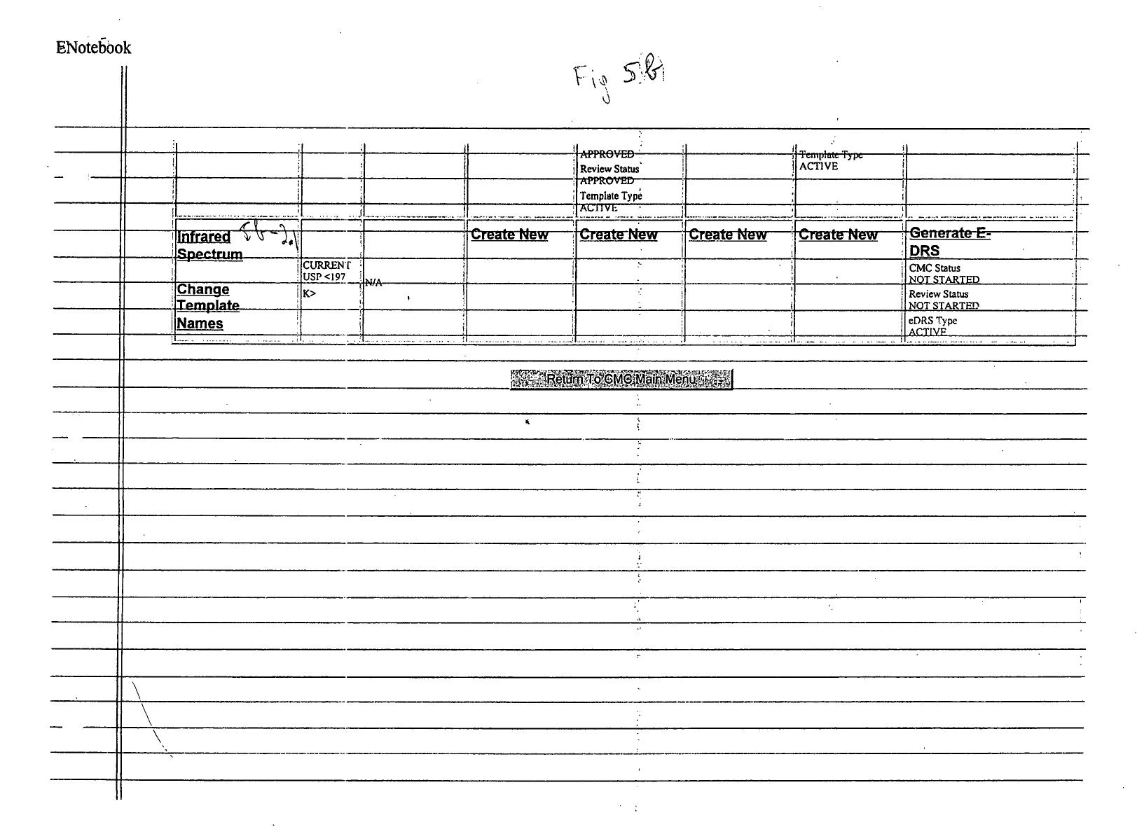

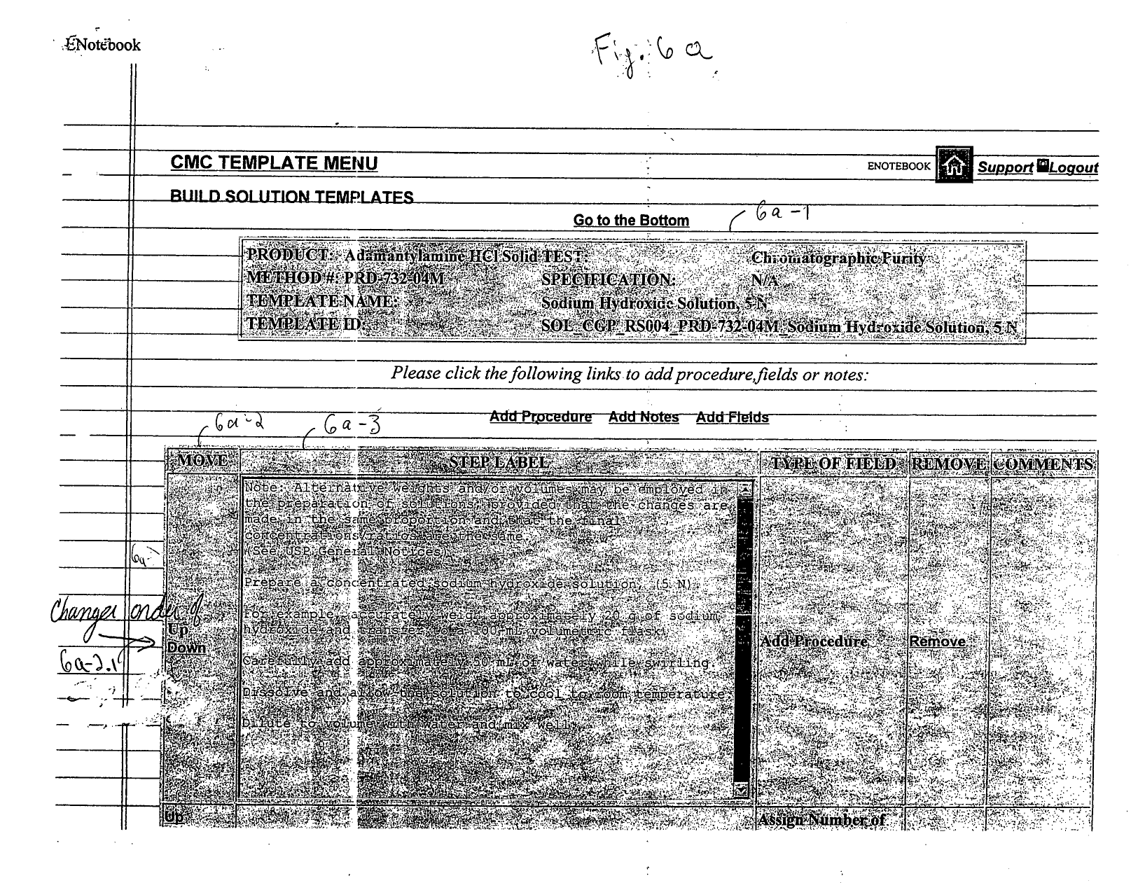

A user, such as a CMC, can create or review a job or template as shown in FIG. 4. For example, a project leader (not shown) using workstation 102 is given a project leader menu 4-1 displayed on workstation 102. This user may select “Review eTemplates/eDRS” 4-2, for example, by clicking on the item in the project leader menu 4-1. The user may then select a study or a product family, and be shown a CMC template menu, as illustratively shown in FIG. 5a.

FIG. 5a shows for a selected product family an electronic data record sheet of templates of a study, for example in an analytic laboratory setting. For selected product family 5a-1, the individual templates are organized by the test that is performed. As shown in column 5a-2, the tests include “chromatographic purity” test 5a-2.1, and “infrared spectrum” test 5b-2. 1, shown in FIG. 5b. For the chromatographic purity test 5a-2.1, a solution prep template, provided in a solution prep column 5a-3, is displayed. Additional templates associated and displayed for the chromatographic purity test 5a-2.1 are a stock standard solutions template 5a-4.1, provided in standard prep column 5a-4, a GC parameters template, provided in column 5a-5, and the purity sample solution template, provided in column 5a-6. Templates listed in the sample prep column 5a-6 are related to tests aimed at determining the strength of an unknown sample that is compared against a product of known strength.

For each test, and for each column in each test, more than one template may be provided, as shown in column 5a-4 and 5a-6 (the second templates in each column are shown in FIG. 5a and continue in FIG. 5b). The particular tests and templates herein designated are intended only as examples of the types of tests and templates that may be generated or edited in the electronic data record sheets.

For example, the information displayed for the sodium hydroxide solution, 5 N template 5a-3.1 provides the user with various types of information about the template, including whether a CMC has approved the procedures encapsulated in the template, the review status and the template type. It will be appreciated that other types of status information or template settings and heading information may be provided as part of the template display.

A user, such as a CMC, may initiate a new study or edit an existing study using the electronic data record sheets. This may be done by using as building blocks previously defined templates or parts of template such as particular tasks contained in the templates, or entire tests, or groups of tests. For example, the user may access previously used studies or tests and copy and paste them, or portions thereof, where relevant into a study, test or template currently being designed or edited. Thereafter, the user may edit or modify the study, test or template that was cut and pasted.

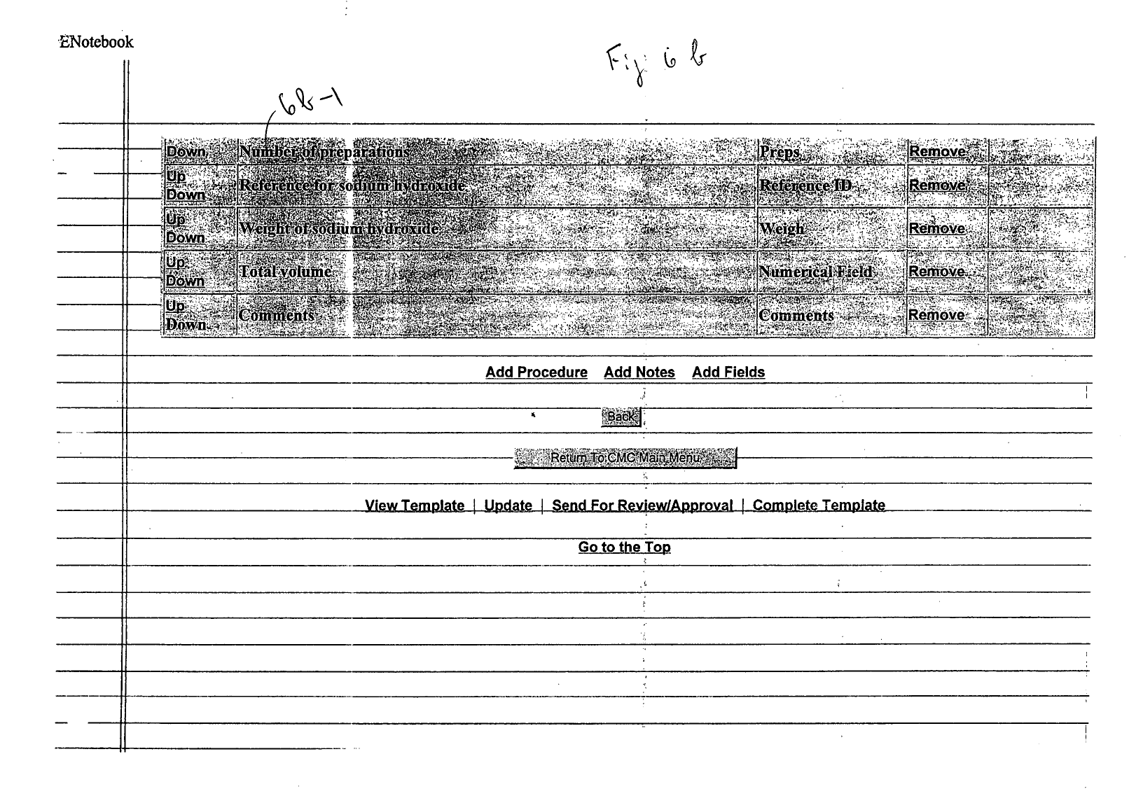

FIG. 6a shows the particular tasks and other associated information contained in the sodium hydroxide solution, 5 N template 5a-3.1. Thus, for example a user interested in more details about that template may select that template from the display shown in FIG. 5a, for example by clicking on the template heading, “sodium hydroxide solution, 5 N”, and then be provided by the system with the template information displayed in FIG. 6a.

Heading 6a-1 displays the product family information, the test, and the template ID, as well as the template name. The template body 6a-3 shows the steps or tasks to be performed in the laboratory as defined by the template. Tasks and steps defined are then performed in the laboratory and the results of the procedures and tests are entered into the system where indicated. For example, as shown in FIG. 6b-1, the number of preparations is entered as shown. Certain types of data may be received from laboratory testing equipment.

According to an embodiment of the present invention, multiple studies may be carried out simultaneously. Lab personnel working on different studies to share jobs and tasks and thus reduce redundancy and improve efficiency. For example, chemists working on different studies that use the same solution can share solution preparation details by linking their studies to the solution. The process for creating the solution can be electronically associated to their studies. Thus, redundant and repetitive procedures are captured once and made available electronically through queries. For example, a procedure such as the calibration of a balance or of a pH meter, is captured electronically and made available for all future users of the balance or the pH meter to insure that the calibration was performed in accordance with their modes of use. Standard preparations and solution preparations are also captured once and made available for future review.

According to an aspect of the present invention, one or more pre-set templates, each template containing a set of tasks, may be pre-defined in the system for the convenience of the user designing a study. Thus, such a user would merely have to combine templates with the predefined content to design the study. Similarly, tests with content information pre-set by users in a related or unrelated study, including templates with pre-loaded tasks to be performed, could also be provided to facilitate re-usability.

The order of tasks may also be changed by authorized users, as shown in the “Up”/“Down” soft buttons 6a-2.1 of column 6a-2. FIG. 6b provides additional information about the contents of the template and for the tasks enumerated thereby. A system according to the invention may be configured to grant certain users, such a CMCs or project leaders the ability to design and change studies, while other laboratory personnel would be allowed only to enter lab data prompted by tasks or steps and/or to execute certain other functions, such as change the order of tasks within a set of tasks.

Thus, the electronic data record sheet according to an embodiment of the present invention may be thought of as a workbench or toolbag that provides a set of blocks or tools for designing, modifying, and editing studies and tests using the building block approach.

It will be appreciated that certain types of operations for electronic data record sheets may be restricted to particular types of users. Thus for instance, only a CMC may be given permission to alter the tasks defined by the template. Upon login, laboratory personnel typically enter and name or user ID, which gives them access and rights to the system as set by a laboratory director, project leader, principal investigator as well as a system owner or manager.

This user-defined feature is helpful because typically, certain sets of tasks or tests occur repeatedly, with only minor modification. Since the present invention provides a user-defined eDRS, the design and modification of studies, tests and templates may be carried out by an end-user, such as a CMC or other laboratory personnel without specific training in software development. An electronic data record notebook, as used herein, may be understood as including one or more electronic data record sheets.

According to an embodiment of the system, additional flexibility of use is provided by allowing laboratory personnel to enter the data as task results in an order different from the order set forth in the tasks of the template. In this way, certain tasks may be carried out in the laboratory before other tasks where possible, and the rigidity of pre-set laboratory procedures may be avoided.

Further, according to an embodiment of the present invention, to provide greater flexibility of use, amounts, quantities, measurements, or readings suggested by the system as set forth in the tasks would not prevent the user from entering data for other quantities or amounts. For example, a task that called for 0.5 ml of a compound would allow the user to enter a quantity based on 1 ml, or based on some other quantity. Such an embodiment would also reduce the waste of otherwise good data based solely on the fact that a quantity different from a suggested quantity had been used.

The system also allows tracking of inventory identification, such as batch numbers or lot numbers or the like of substances used to generate laboratory information and the identification of instrument parts or other containers used to the laboratory information. The template of the electronic data record sheet may include inventory identification, such as a batch number (or lot number, stock number, bar code, or other information matching the substance with inventory information) of a substance to be used to generate laboratory information, and may further include an identification (e.g. a bar code, or other unique identifier of the part or container) of an instrument, or part of an instrument or of a container used in the instrument or for some other part or container used to generate laboratory information, for example, a tray, a column, a tube, or a beaker that is to be used for a task or step.

The laboratory personnel may then record such information associated with the laboratory data. This “drill-down” feature promotes efficiency, because lab personnel know what specific lots or batches of chemicals or substances and which specific instrument parts and containers are available and convenient. Further, after the information is entered, the drill-down feature allows subsequent tracing of such substances or instruments that could be used to determine the manufacturer or to verify the potency, usability, or the like.

However, according to an aspect of the present invention, lab personnel may have the option of using substances or instrument parts or containers other than those specified, for example, if the specified ones have become unavailable, and the system will still accept the data. Accordingly, the inventory identification, such as a batch number or lot number of the substance actually used, or the identification of the instrument part or container actually used would be entered and associated with the data, to allow subsequent tracing.

Further, according to an aspect of the present invention, laboratory personnel who perform tasks specified in a template have access to inventory information and product availability information that is stored in the system. Therefore, in performing tasks that are specified by the system, they have access to information about what items (substances, products, instruments, instrument parts or the like) are available. Further, according to an aspect of the present invention, when an item is used in the laboratory, the system may record the use of the item linked with the test and the task for which the item is used. This provides the ability to trace the items that were used for a test or task, and provides inventory information for other users. For example, if a product is generated in a procedure, this information could be made instantly available to other users.

According to an aspect of the present invention, a single specified test is structured by its creator (for example, by a CMC or equivalent) in the format of a re-usable workflow structure sometimes referred to an “eDRS” or “Electronic Data Record Sheet” specific to a product family. However, the eDRS may be replicated and extended for testing samples of another related or non-related product family thereby promoting extensibility and template re-use across tests for products.

The Electronic Notebook comprises the aggregation of a plurality of eDRS workflow entities which have been populated with sample-specific testing results, including for example, data from a job. Data specific to each sample from a Job and collected in its eDRS structured format is stored in the database under its unique sample identifier (study_id) such that upon completely populating the study-specific eDRSs with testing result/data, the eNotebook gets generated for the sample.

According to an aspect of the present invention, an assembly line approach may be set up by defining a job. A job is a defined test, typically to be performed by one laboratory technician or chemist, for each sample of a group of samples of a related product family. The defined test may include several templates, such as for example, sample prep, standard prep, solution prep and instrument prep.

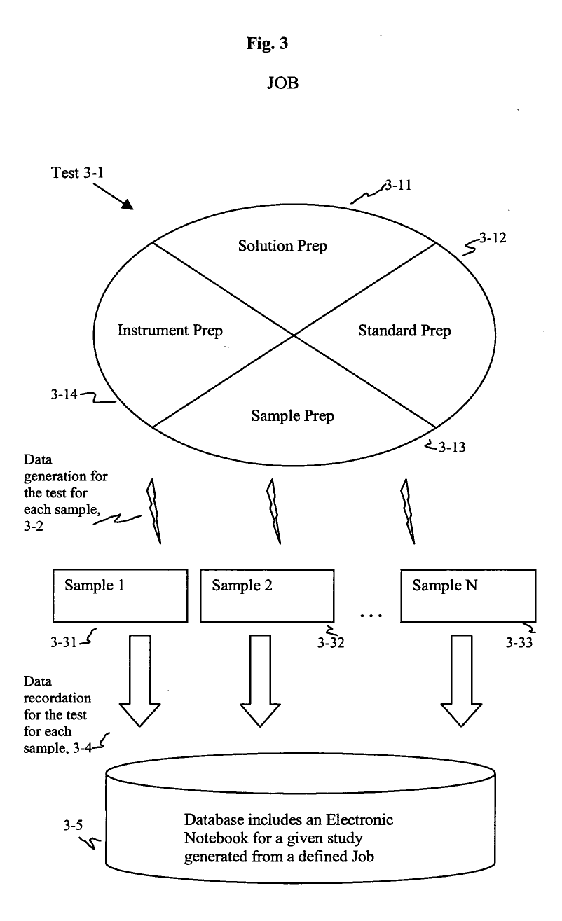

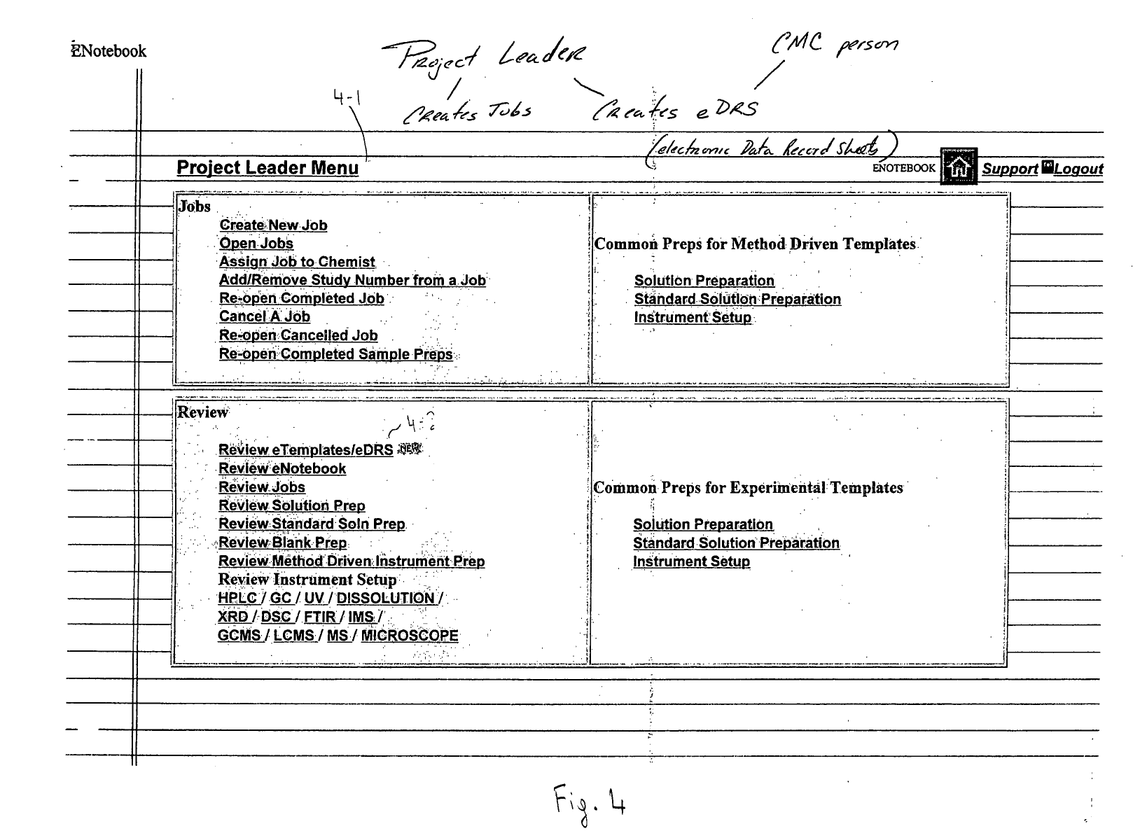

FIG. 3 shows a test 3-1 defined for a job. The test 3-1 comprises several templates, for example, solution prep 3-11, standard prep 3-12, sample prep 3-13, and instrument prep 3-14, each template, as discussed including a set of tasks to be performed by one or more laboratory personnel. The job prescribes that the test 3-1 is to be performed on each sample of a set of samples: sample 1 (3-31), sample 2 (3-32), sample N (3-33) from a related product family, N being an integer greater than 2 (the job may prescribe as few or as many samples as desirable). When the test is performed on each sample, laboratory data are generated (3-2) and stored in an eDRS. The set of eDRSs thus populated by laboratory personnel comprise an eNotebook for the sample (and identified by its study identifier) that is stored in database 3-4. Thus, for example, if a particular set of samples, typically all the samples from the same product family, are to undergo the same test then a project leader or the like may specify a job for the system.

A sample is referenced by its sample identifier (or study_id) numerous times within different jobs based on the required number of tests. Aggregation of sample-specific data populated from the eDRS in a job results in an eNotebook for that specific sample. The eNotebook may be subjected to pre-determined review and approval by requisite authority and specific process points and subject to final QA approval. It should be noted that due to the online real-time nature of the product, review, verification and approval is possible at any point during the testing process, and before the testing process, templates or tests specified for execution may undergo review and authorization.

In-built process validation enforces laboratory process and protocol, and minimizes re-work and investigations.

### Research Lab Embodiment

According to an embodiment of the present invention, the steps or tasks of a study may be defined without reference to tests or to templates. This embodiment would be of particular relevance in an experimental or research laboratory setting, as opposed to an analytic laboratory, setting.

Typically, in such embodiment, a user, not merely a CMC, would be able to define steps for the following elements: solution prep, standard prep, instrument setup, and sample analysis. In such an embodiment, the electronic Notebook would provide even more flexibility for the user in defining laboratory tasks or steps. The drill-down feature would be available for the research laboratory environment as well.

Described was an invention that includes a method-driven laboratory information system that provides reusability of tests, templates and other modules that have been specified, including re-use across product family types, and is extensible. Such an invention has application in a variety of laboratories, including for example, in a pharmaceutical laboratory setting, a chemical laboratory setting, a biological, nucleotide, sequencing, laboratory setting or the like. Further, a system according to the invention may be implemented, for example, in a completely paperless manner.

Embodiments of the present invention provided in the foregoing written description are intended merely as illustrative examples. It will be understood however, that the scope of the invention is provided in the claims.

1. A laboratory activity electronic management system comprising:
a first processor configured to execute a set of instructions; and
a second processor logically connected to said first processor, said second processor enabled by the set of instructions executed by said first processor to enable a generation of an electronic data record sheet for a study for a product family, the study comprising at least one test, the test comprising at least one template that includes at least one task to be executed in a laboratory and status information for the task, an order of the study, the test, the template and the task being defined by a user operating said second processor; and
said second processor configured to enable a second user to enter generated laboratory information into the electronic data record sheet, the laboratory information generated in accordance with the execution of the task,
wherein said first processor is configured to store the electronic data record sheet with the entered laboratory information from said second processor, such that the template of the stored electronic data record sheet includes inventory identification of a substance used to generate the laboratory information and an instrument part exposed to the substance used in an instrument for the execution of the task.

2. The system of claim 1, wherein the test comprises at least one of a solution preparation template, at least one standard preparation template, at least one instrument preparation template, and at least one sample analysis template.

3. The system of claim 1, wherein the set of instructions executed by said first processor enables a generation of a job, the job being a workflow entity comprising a single specified test to be performed in the laboratory for each sample of a specified group of samples, the samples being different from each other and belonging to the same or related product family.

4. The system of claim 1, wherein the second user is enabled to record in the generated electronic data record sheet at least one of a quantity and a measurement different from the quantity and the measurement suggested by the task.

5. The system of claim 1, wherein the inventory identification of at least one of a substance and the instrument part stored into the electronic data record sheet is different from the inventory identification of at least one of the batch number and the instrument part specified in the generated template.

6. The system of claim 1, wherein an inventory of items maintained by the system reflects the inventory identification of an item stored into the electronic data record sheet and, based on the inventory of item maintained, item availability information is provided to users who view any template.

7. The system of claim 1, wherein the user records into the generated electronic data record sheet results of a task performed in the order of the sequence defined by the generated electronic data record sheet.

8. An experimental laboratory activity electronic management system comprising:
a first processor configured to execute a set of instructions; and
a second processor logically connected to said first processor, said second processor enabled by the set of instructions executed by said first processor to enable a generation of an electronic data record notebook for a study comprising a plurality of steps to be executed in a laboratory and status information for the steps, an order of the steps defined by a user operating said second processor; and
said second processor configured to enable the user to enter generated laboratory information into the electronic data record sheet, the laboratory information generated in accordance with the execution of the steps,
wherein said first processor is configured to store the electronic data record notebook with the entered laboratory information from said second processor, such that the stored electronic data record notebook includes an inventory identification of a substance used to generate the laboratory information and an instrument part exposed to the substance used in an instrument for the execution of the steps.

9. The system of claim 8, wherein the user is enabled to record into the generated electronic data record sheet at least one of a quantity and a measurement different from the quantity and the measurement suggested by a step of the plurality of steps.

10. The system of claim 8, wherein the inventory identification stored into the electronic data record notebook by a laboratory worker is different from the inventory identification previously stored by a laboratory worker into the generated electronic data record notebook.

11. A data processor-readable medium incorporating a program executable by a first processor, the program comprising:
instructions configured to enable a generation, by a user operating a second processor logically connected to the first processor, of an electronic data record sheet for a study for a product family, the study comprising at least one test, the test comprising at least one template that includes at least one task to be executed in a laboratory and status information for the task, an order of the study, the test, the template and the task being defined by the user;
said instructions further configured to enable a second user operating the second processor to enter generated laboratory information into the electronic data record sheet, the laboratory information generated in accordance with the execution of the task; and
instructions configured to cause the first processor to store the electronic data record sheet with the entered laboratory information from said second processor, such that the template of the stored electronic data record sheet includes an inventory identification of a substance used to generate the laboratory information and an instrument part exposed to the substance used in an instrument for the execution of the task.

12. The medium of claim 11, wherein the test comprises at least one of a solution preparation template, at least one standard preparation template, at least one instrument preparation template, and at least one sample analysis template.

13. The medium of claim 11, further comprising instructions configured to or enable a generation of a job, the job being a workflow entity comprising a single specified test to be performed in the laboratory for each sample of a specified group of samples, the samples being different from each other and belonging to the same product family.

14. The medium of claim 11, wherein the second user is enabled to record in the generated electronic data record sheet at least one of a quantity and a measurement different from the quantity and the measurement suggested by the task.

15. The medium of claim 11, wherein the inventory identification stored into the electronic data record sheet is different from the inventory identification previously stored in the generated template.

16. The medium of claim 11, wherein the user may record into the generated electronic data record sheet results of a task performed in the order of the sequence defined by the generated electronic data record sheet. record sheet.
